(19) United States
(12) Patent Application Publication
(10) Pub. No.: US 2021/0327670 A1
(43) Pub. Date: Oct. 21, 2021

(54) ELECTRONIC COMPONENT MODULE

(71) Applicant: Panasonic Intellectual Property Management Co., Ltd., Osaka (JP)

(72) Inventors: KEISUKE MORI, Osaka (JP); HIDEKI WATANABE, Osaka (JP)

(21) Appl. No.: 16/973,465

(22) PCT Filed: May 28, 2019
(86) PCT No.: PCT/JP2019/020984

§ 371 Date: Dec. 9, 2020

(30) Foreign Application Priority Data
Jul. 4, 2018 (JP) 2018-127203

(51) Int. Cl. H01H 50/14; H01H 89/00; H01H 85/143; H01H 50/02; H01H 45/12

(52) U.S. Cl. CPC H01H 50/14; H01H 89/00; H01H 45/12; H01H 50/02; H01H 85/143

(57) ABSTRACT

An electronic component module according to the present disclosure includes a fuse, a relay, a first conductor, a first connecting conductor, a second conductor, a second connecting conductor, and a third conductor. The first conductor, the second conductor, and the third conductor are arranged in the order of the third conductor, the second conductor, and the first conductor in a first direction. A first fuse terminal is connected to a plate-shaped portion of the first connecting conductor. A second fuse terminal is connected to a plate-shaped portion of the second connecting conductor. A first relay terminal is connected to an end of the second conductor that is located in a direction opposite to the first direction. A second relay terminal is connected to an end of the third conductor that is located in the first direction.

### TECHNICAL FIELD

The present disclosure relates to electronic component modules that are used in various electronic devices.

### BACKGROUND ART

Hereinafter, a conventional electronic component module is described with reference to the Drawings. FIG. 7 is an external side view illustrating the configuration of the conventional electronic component module. Electronic component module 1 includes relay 2, fuse 3, first outer conductor 4, second outer conductor 5, and inner conductor 6.

First outer conductor 4 is connected to fuse 3, second outer conductor 5 is connected to relay 2, and inner conductor 6 is connected to relay 2 and fuse 3. First outer conductor 4, second outer conductor 5, and inner conductor 6 are electric conductors, and first outer conductor 4, second outer conductor 5, and inner conductor 6 have a function of dissipating heat from electronic component module 1 to the outside.

Note that Patent Literature (PTL) 1, for example, is known as related art document information pertaining to the present application.

### CITATION LIST

### Patent Literature

PTL 1: Unexamined Japanese Patent Publication No. 2014-079093

### SUMMARY OF THE INVENTION

An electronic component module according to one aspect of the present disclosure includes: a fuse including a fuse main body, a first fuse terminal, and a second fuse terminal; a relay including a relay main body, a first relay terminal, and a second relay terminal; a first conductor having the shape of a plate, the first conductor being along a first direction and a second direction orthogonal to the first direction; a first connecting conductor extending from the first conductor in a third direction crossing the first direction and the second direction, the first connecting conductor including a plate-shaped portion being along the first direction and the third direction; a second conductor having a shape of a plate, the second conductor being along the first direction and the second direction; a second connecting conductor extending from the second conductor in the third direction and including a plate-shaped portion being along the first direction and the third direction; and a third conductor having a shape of a plate, the third conductor being along the first direction and the second direction. The first conductor, the second conductor, and the third conductor are arranged in the order of the third conductor, the second conductor, and the first conductor in the first direction. The first fuse terminal is connected to the plate-shaped portion of the first connecting conductor. The second fuse terminal is connected to the plate-shaped portion of the second connecting conductor. The first relay terminal is connected to an end of the second conductor that is located in a direction opposite to the first direction. The second relay terminal is connected to an end of the third conductor that is located in the first direction.

According to the present disclosure, it is possible to improve the heat dissipation properties of an electronic component module without increasing the size thereof.

### BRIEF DESCRIPTION OF THE DRAWINGS

FIG. 1 is an external side view illustrating the configuration of an electronic component module according to Embodiment 1 of the present disclosure.

FIG. 2 is an external perspective view illustrating the configuration of an electronic component module according to Embodiment 1 of the present disclosure.

FIG. 3 is an external side view illustrating the configuration of an electronic component module according to Embodiment 2 of the present disclosure.

FIG. 4 is an external side view illustrating the configuration of an electronic component module according to Embodiment 3 of the present disclosure.

FIG. 5 is an external perspective view illustrating the configuration of an electronic component module according to Embodiment 4 of the present disclosure.

FIG. 6 is an external perspective view illustrating the configuration of an electronic component module according to Embodiment 5 of the present disclosure.

FIG. 7 is an external side view illustrating a conventional electronic component module.

### DESCRIPTION OF EMBODIMENTS

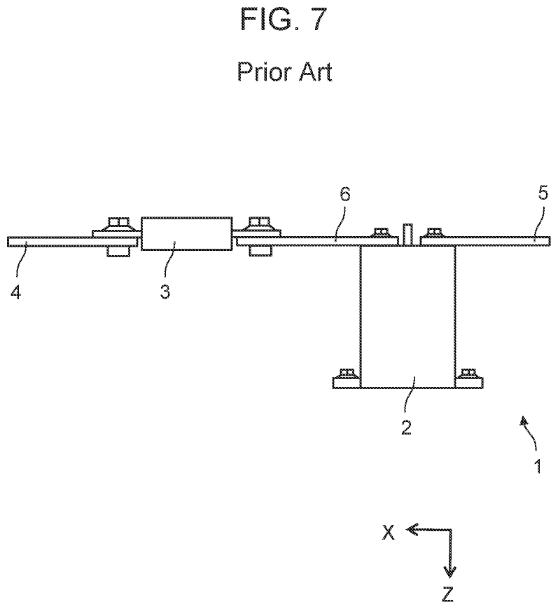

In above conventional electronic component module 1 illustrated in FIG. 7, the improvement of the heat dissipation properties results in an increase in the areas of first outer conductor 4, second outer conductor 5, and inner conductor 6. Along with an increase in the areas of first outer conductor 4, second outer conductor 5, and inner conductor 6, electronic component module 1 also increases in size. On the other hand, downsizing of electronic component module 1 may cause deterioration of the heat dissipation properties. In other words, the downsizing of electronic component module 1 and the improvement of the heat dissipation properties thereof contract each other; thus, it is difficult to downsize electronic component module 1 and improve the heat dissipation properties thereof at the same time.

Hereinafter, exemplary embodiments of the present disclosure are described with reference to the Drawings.

### Embodiment 1

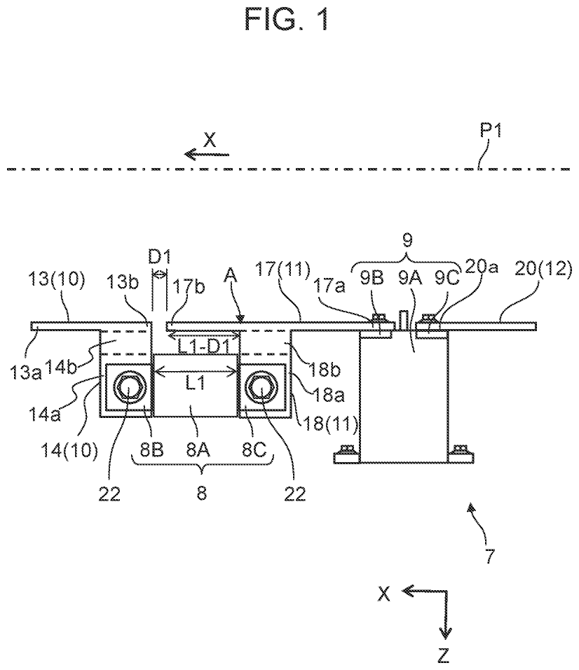

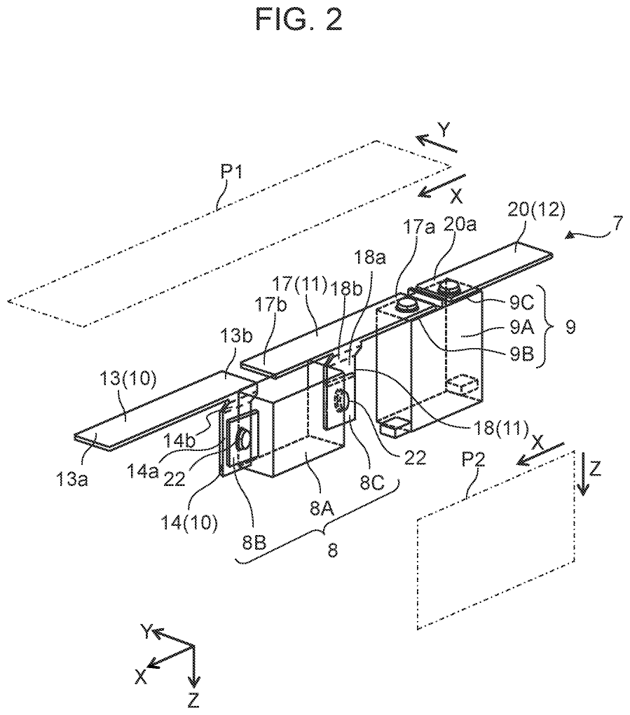

FIG. 1 is an external side view illustrating the configuration of electronic component module 7 according to Embodiment 1 of the present disclosure, and FIG. 2 is an external perspective view illustrating the configuration of electronic component module 7 according to Embodiment 1 of the present disclosure.

Electronic component module 7 includes fuse 8, relay 9, first busbar 10, second busbar 11, and third busbar 12. Fuse 8 includes fuse main body 8A, first fuse terminal 8B, and second fuse terminal 8C. Relay 9 includes relay main body 9A, first relay terminal 9B, and second relay terminal 9C.

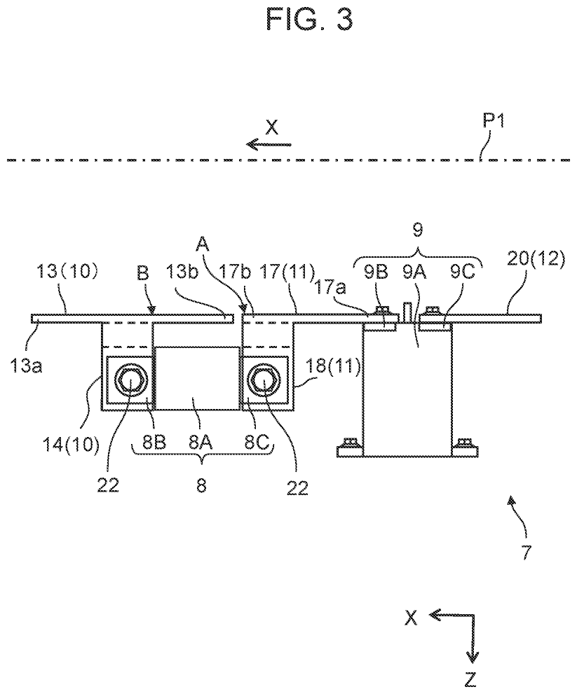

In the present disclosure, description is made using first plane P1 (refer to FIG. 1 to FIG. 3) which is a virtual plane and second plane P2 (refer to FIG. 2) which is a virtual plane. First plane P1 illustrated in FIG. 1 to FIG. 3 is a plane extending along an X direction and a Y direction (refer to FIG. 2). Note that in FIG. 1 and FIG. 3, the Y direction denotes a direction from the front to the back of the Drawings. Second plane P2 illustrated in FIG. 2 is a plane extending along the X direction and a Z direction. This means that first plane P1 and second plane P2 are orthogonal to each other.

Note that in the present disclosure, although there are case where description is made using terms indicating directions such as “up/above”, “low/below”, “left”, and “right” for ease of explanation, these merely indicate relative positioning and do not limit the present disclosure.

First busbar 10 includes first conductor 13 and first connecting conductor 14. First conductor 13 is a plate-shaped conductor extending along first plane P1. First conductor 13 includes an end in the X direction (hereinafter referred to as end 13a) and an end in the direction opposite to the X direction (hereinafter referred to as end 13b). First connecting conductor 14 is a plate-shaped conductor extending from first conductor 13 in the Z direction. First connecting conductor 14 extends along second plane P2 except for a portion of first connecting conductor 14 that is connected to first conductor 13. First fuse terminal 8B is connected to first connecting conductor 14.

Second busbar 11 includes second conductor 17 and second connecting conductor 18. As with first conductor 13, second conductor 17 is a plate-shaped conductor extending along first plane P1. First relay terminal 9B is connected to an end of second conductor 17 that is located in the direction opposite to the X direction (hereinafter referred to as end 17a). An end of second conductor 17 that is located in the X direction (hereinafter referred to as end 17b) faces end 13b of first conductor 13. In Embodiment 1, end 17b of second conductor 17 faces end 13b of first conductor 13 at a distance having length D1, as illustrated in FIG. 1. Second connecting conductor 18 is a conductor extending from second conductor 17 in the Z direction. Second connecting conductor 18 extends along second plane P2 except for a portion of second connecting conductor 18 that is connected to second conductor 17. Second fuse terminal 8C is connected to second connecting conductor 18.

Third busbar 12 includes third conductor 20 having the shape of a plate extending along first plane P1 as with first conductor 13 and second conductor 17. Second relay terminal 9C is connected to an end of third conductor 20 that is located in the first direction (X direction) (hereinafter referred to as end 20a).

In first busbar 10, first conductor 13 has the function of dissipating heat, and in the second busbar, second conductor 17 has the function of dissipating heat.

With the above configuration, fuse main body 8A, in particular, of fuse 8 is disposed in a plane different from a plane in which first conductor 13 and second conductor 17 having the function of dissipating heat are disposed. In other words, fuse 8 (particularly, fuse main body 8A) is not located in a region between first conductor 13 and second conductor 17.

For example, in the conventional electronic component module illustrated in FIG. 7, fuse 3 is located in a region between first outer conductor 4 (corresponding to first conductor 13 in the present exemplary embodiment) and inner conductor 6 (corresponding to second conductor 17 in the present exemplary embodiment), and thus electronic component module 1 is long in the X direction.

In contrast, in the present exemplary embodiment, fuse 8 is disposed in dead space located below (in the Z direction from) first conductor 13 and below (in the Z direction from) second conductor 17, and thus the length of electronic component module 7 in the X direction can be reduced.

Therefore, it is possible to dispose fuse 8 without changing the overall size of electronic component module 7. In other words, when the related art illustrated in FIG. 7 and the present exemplary embodiment illustrated in FIG. 1 are compared, assuming that the lengths in the X direction are the same, first conductor 13 and second conductor 17 in electronic component module 7 illustrated in FIG. 1 can be made longer in the X direction than those in electronic component module 1 illustrated in FIG. 7. In electronic component module 7 in the present exemplary embodiment, it is possible to increase the surface areas of first conductor 13 and second conductor 17, making it possible to improve the heat dissipation properties of electronic component module 7.

A large amount of heat that is likely to be generated at relay 9 (first relay terminal 9B) is discharged to the outside through second conductor 17 before being transferred to fuse 8. This means that in the present exemplary embodiment, the heat generated at relay 9 is less likely to be transferred to fuse 8. Thus, fuse 8 is less affected by the heat from the outside of fuse 8 (for example, the heat from relay 9) that is not related to heat generated at fuse main body 8A. As a result, fuse 8 can appropriately reflect the properties thereof regarding interruption of an electric current, and thus the operation reliability of fuse 8 improves.

Details on the configuration of electronic component module 7 are described below. As mentioned earlier, electronic component module 7 includes fuse 8, relay 9, first busbar 10, second busbar 11, and third busbar 12, as illustrated in FIG. 1 and FIG. 2. Fuse 8 includes fuse main body 8A, first fuse terminal 8B, and second fuse terminal 8C. Relay 9 includes relay main body 9A, first relay terminal 9B, and second relay terminal 9C.

Fuse main body 8A has a function of transitioning from a connected state to a disconnected state when an abnormal current such as an electric current having a value greater than a threshold value is supplied to fuse 8. This interruption function of fuse main body 8A is achieved by blowing or cutting using mechanical external force, for example. In Embodiment 1, the method for achieving this function is not particularly specified. Furthermore, this interruption function may be achieved by fuse 8 blowing according to thermal properties thereof. The interruption by fuse 8 may be achieved according to an instruction, control, or the like from a sensor (not illustrated in the drawings) or a control device (not illustrated in the drawings) provided as an element separate from fuse 8. In Embodiment 1, the method for controlling the interruption by fuse 8 is not particularly specified.

Relay main body 9A has a function of selectively switching between the connected state and the disconnected state. Whether relay main body 9A is connected or disconnected is determined by a sensor (not illustrated in the drawings), a control device (not illustrated in the drawings), or the like provided as an element separate from relay 9.

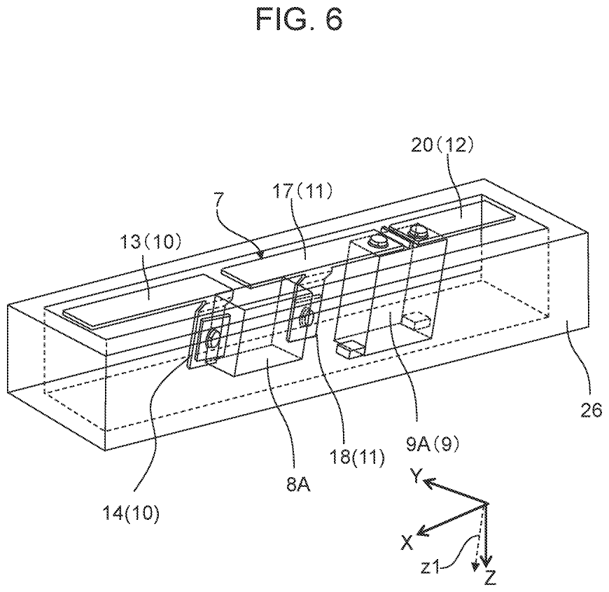

First busbar 10 includes first conductor 13 and first connecting conductor 14. First conductor 13 is a plate-shaped conductor extending along virtual first plane P1, and first connecting conductor 14 is provided along virtual second plane P2 orthogonal to virtual first plane P1. In other words, first busbar is a single plate-shaped conductor, and first connecting conductor 14 is provided in the bent state at the right angle to first conductor 13. As illustrated in FIG. 2, first connecting conductor 14 includes: plate-shaped portion 14a extending along the X direction and the Z direction; and bent portion 14b obtained by bending first connecting conductor 14 in the Z direction from first conductor portion 13. In Embodiment 1, first conductor 13 and plate-shaped portion 14a of first connecting conductor 14 are orthogonal to each other, but do not always need to be orthogonal to each other. It is sufficient that the region of first connecting conductor 14 to which first fuse terminal 8B is connected using fixing tool 22 extend at approximately 90 degrees to first conductor 13. For example, first conductor 13 and first connecting conductor 14 do not always need to be orthogonal to each other as in the exemplary embodiment illustrated in FIG. 6 to be described later.

The same as first busbar 10 applies to second busbar 11; second busbar 11 is a single plate-shaped conductor, and second connecting conductor 18 is provided in the bent and extended state at the right angle to second conductor 17. Second connecting conductor 18 includes plate-shaped portion 18a and bent portion 18b. In Embodiment 1, second conductor 17 and second connecting conductor 18 are orthogonal to each other, but do not always need to be orthogonal to each other. It is sufficient that the region of second connecting conductor 18 to which second fuse terminal 8C is connected using fixing tool 22 extend at approximately 90 degrees to the plane in which first conductor 13 is provided. For example, second conductor 17 and second connecting conductor 18 do not always need to be orthogonal to each other as in Embodiment 5 illustrated in FIG. 6 to be described later.

In the present exemplary embodiment, first fuse terminal 8B is connected to plate-shaped portion 14a of first busbar 10 using fixing tool 22. Second fuse terminal 8C is connected to plate-shaped portion 18a of second busbar 11 using fixing tool 22. First relay terminal 9B is connected to second busbar 11 using fixing tool 22. Second relay terminal 9C is connected to third busbar 12 using fixing tool 22. However, fixing of fuse 8 and first busbar 10, fixing (or electrical connection) of fuse 8 and second busbar 11, fixing (or electrical connection) of relay 9 and second busbar 11, and fixing (or electrical connection) of relay 9 and third busbar 12 are not always achieved using fixing tool 22 such as a bolt, a nut, and a screw. Each fixing may be fixing (or electrical connection) by welding such as soldering.

First conductor 13 includes end 13a located in the X direction and end 13b located in the direction opposite to the X direction. In other words, first conductor 13 includes two ends (end 13a, end 13b); the end close to fuse 8 is end 13b, and the end distant from fuse 8 is end 13a. In the present exemplary embodiment, no device or the like is connected to end 13a, but since end 13a is located at a distance from fuse 8 and relay 9, a load or the like may be connected to end 13a. Furthermore, end 13a may be used as an output terminal. The state in which nothing is connected to end 13a, as illustrated in FIG. 2, is not necessarily required.

Furthermore, in the present exemplary embodiment, first conductor 13, second conductor 17, and third conductor 20 are each in the shape of a plate and are disposed in substantially the same plane. However, it is sufficient that first conductor 13, second conductor 17, and third conductor 20 be disposed substantially parallel to one another in the state of extending along virtual first plane P1. Note that first conductor 13, second conductor 17, and third conductor 20 do not always need to be disposed in the same plane.

In Embodiment 1, fuse 8 is disposed in the dead space located below (in the Z direction from) first conductor 13 and second conductor 17, and thus first conductor 13 and second conductor 17 can be enlarged according to the size of fuse main body 8A. On the other hand, even if the size of fuse main body 8A increases, first conductor 13 and second conductor 17 do not need to be downsized in the X direction. Thus, the dimensions of first conductor 13 and second conductor 17, each of which has the function of dissipating heat, in the X direction and the Y directions can be increased according to the dimensions of fuse main body 8A. Therefore, even if a heat generation source is connected to end 13a, it is easy to increase the length, the area, etc., of first conductor 13, making it possible to improve the heat dissipation properties of entire electronic component module 7.

As illustrated in FIG. 1, the distance between end 13b and end 17b is denoted herein as length D1. Note that end 13b and end 17b are not in contact with each other, are electrically insulated from each other, and face each other. The length of fuse main body 8A of fuse 8 in the X direction is denoted as length L1. As described above, second connecting conductor 18 extends from second conductor 17. In the area where second connecting conductor 18 and second conductor 17 are in contact, the edge of second connecting conductor 18 that is located in the X direction is denoted as position A (refer to FIG. 1). In this case, the length between position A and the edge of end 17b of second conductor 17 that is located in the X direction is length (L1-D1). This means that in the present exemplary embodiment, end 17b can be extended from position A in the X direction by length (L1-D1). The area, along first plane P1, of an expanded surface of second conductor 17 that corresponds to this extension contributes to the improvement of the heat dissipation properties of electronic component module 7.

### Embodiment 2

FIG. 3 is an external side view illustrating the configuration of electronic component module 7 according to Embodiment 2. Note that elements that are substantially the same as those in Embodiment 1 described above are assigned the same reference marks and description thereof may be omitted. In Embodiment 1 illustrated in FIG. 1, first connecting conductor 14 extends from end 13b of first conductor 13 in the Z direction. In contrast, in Embodiment 2 illustrated in FIG. 3, first connecting conductor 14 extends from a region between end 13a and end 13b in the Z direction. In the area where first connecting conductor 14 and first conductor 13 are in contact, the edge of first connecting conductor 14 that is located in the direction opposite to the X direction is denoted as position B (refer to FIG. 3). End 13b of first conductor 13 extends from position B in the direction opposite to the X direction. In the present exemplary embodiment, first conductor 13 extends to achieve expansion in the direction opposite to the X direction; thus, the area, along first plane P1, of an expanded surface of first conductor 13 that corresponds to this extension contributes to the improvement of the heat dissipation properties of electronic component module 7.

In particular, although not illustrated in the drawings, when a device, etc., serving as a heat generation source is connected to end 13a, the effect of heat dissipation improves according to the expansion of the surface area of first conductor 13, and thus the heat transfer from end 13a to fuse 8 is reduced. Therefore, fuse 8 is less affected by the heat from the outside of fuse 8 that is not related to heat generated at fuse main body 8A. As a result, fuse can appropriately reflect the properties thereof regarding interruption of an electric current, and thus the operation reliability of fuse 8 improves.

In Embodiment 2 illustrated in FIG. 3, second connecting conductor 18 extends in the Z direction from the end (end 17b) of second conductor 17 that is located in the X direction; however, second conductor 17 may extend from position A in the X direction in the present exemplary embodiment, as in Embodiment 1 described with reference to FIG. 1. In this case, second connecting conductor 18 extends in the Z direction from a region between end 17a and end 17b. In this case, the area of second conductor 17 expanded in the X direction contributes to the improvement of the heat dissipation properties of electronic component module 7. Furthermore, the path for an electric current flowing between fuse 8 and relay 9 is shortened, and the direct-current resistance between fuse 8 and relay 9 is reduced, and the amount of heat that is generated due to the direct-current resistance is also reduced. Moreover, in second conductor 17, the area between position A and the edge of second conductor 17 that is located in the X direction, which is a region where the direct-current resistance does not increase, increases. As a result, the heat transfer from end 17a to fuse 8 is reduced. Therefore, fuse 8 is less affected by the heat from the outside of fuse 8 that is not related to heat generated at fuse main body 8A. As a result, fuse 8 can appropriately reflect the properties thereof regarding interruption of an electric current, and thus the operation reliability of fuse 8 improves.

The length of end 17b of second conductor 17 extending in the X direction or the position of second connecting conductor 18 extending at the right angle can be determined, as appropriate, according to the dimensions of fuse main body 8A of fuse 8. Therefore, if fuse main body 8A of fuse 8 has large dimensions, it is possible to increase the area of first conductor 13 or second conductor 17 along first plane P1 according to the size of fuse main body 8A, and thus there is no need to enlarge electronic component module 7 in order to increase the areas of first conductor 13 and second conductor 17 along first plane P1. The heat dissipation through first conductor 13 or second conductor 17 can improve according to the size of fuse main body 8A without enlargement of electronic component module 7.

### Embodiment 3

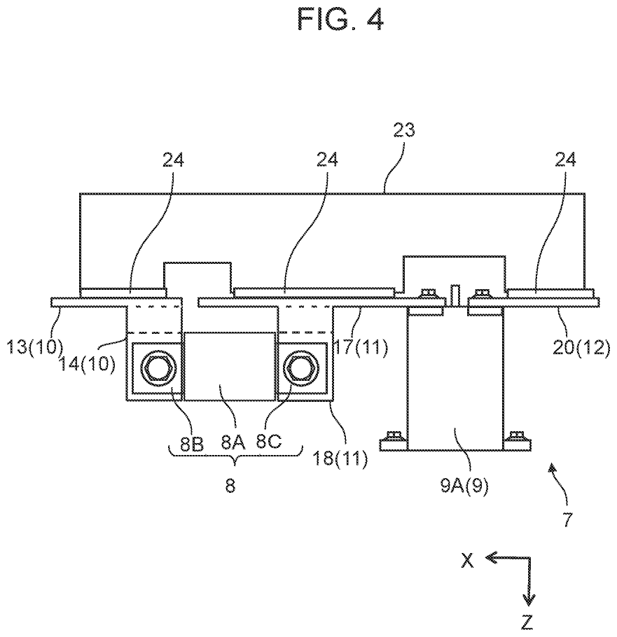

FIG. 4 is an external side view illustrating the configuration of electronic component module 7 according to Embodiment 3. Electronic component module 7 according to Embodiment 3 illustrated in FIG. 3 is different from electronic component module 7 according to Embodiment 1 illustrated in FIG. 1 in that heat dissipator 23 which is thermally coupled to first conductor 13 (first busbar 10), second conductor 17 (second busbar 11), and third conductor 20 (third busbar 12) is provided. With this configuration, the heat generated at fuse 8 or relay 9 is efficiently discharged from first conductor 13, second conductor 17, or third conductor 20 to the outside of electronic component module 7. As described earlier, fuse main body 8A, in particular, of fuse 8 is disposed below (in the Z direction from) first conductor 13 having the function of dissipating heat for first busbar 10 and second conductor 17 having the function of dissipating heat for second busbar 11. With this configuration, at least one of first conductor 13 and second conductor 17 can be extended to space located above (in the direction opposite to the Z direction from) fuse main body 8A without increasing the overall size of electronic component module 7. Thus, the area of at least one of first conductor 13 and second conductor 17 can be increased, and the efficiency of heat transfer from at least one of first conductor 13 and second conductor 17 to heat dissipator 23 improves. In the present exemplary embodiment, it is possible to improve the heat dissipation properties of electronic component module 7.

Note that insulating layer 24 is desirably provided between heat dissipator 23 and each of first busbar 10, second busbar 11, and third busbar 12, as illustrated in FIG. 4. Insulating layer 24 desirably has insulating properties and high heat transfer properties.

In electronic component module 7 in the present exemplary embodiment, the thermal relationship between fuse 8 and relay 9 can be weakened, and thus fuse 8 can appropriately reflect the properties thereof regarding interruption of an electric current. Therefore, the operation reliability of fuse 8 improves.

Heat dissipator 23 may be formed from a metal having excellent heat transfer properties or heat dissipation properties with a fin. Heat dissipator 23 may be a cooler, a heat exchanger, or the like having not only a heat dissipation function, but also a cooling function, and including a flow path for a gaseous or liquid cooling medium to flow for heat exchange.

### Embodiment 4

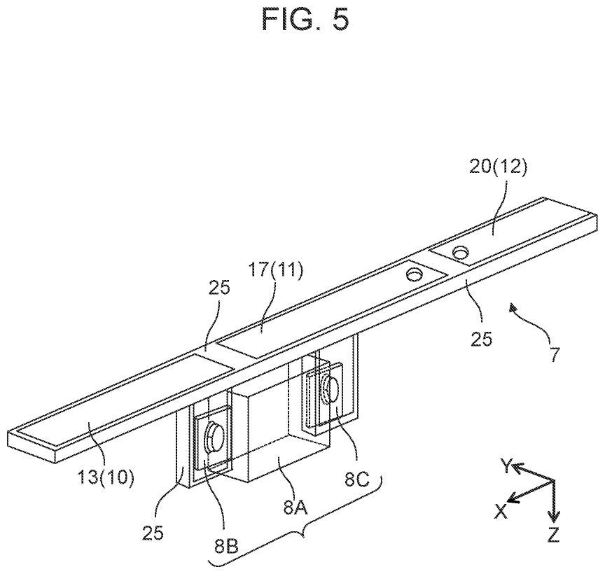

FIG. 5 is an external perspective view illustrating the configuration of electronic component module 7 according to Embodiment 4. Note that elements that are substantially the same as those in Embodiment 1 described above are assigned the same reference marks and description thereof may be omitted. In Embodiment 4 illustrated in FIG. 5, electronic component module 7 illustrated in FIG. 1 further includes resin frame 25 which fixes first busbar 10, second busbar 11, and third busbar 12. Note that although relay 9 is not illustrated in FIG. 5, relay 9 is, in actuality, disposed as in other exemplary embodiments. Furthermore, also in the present exemplary embodiment, heat dissipator 23 (refer to FIG. 4) may be disposed as in Embodiment 3 illustrated in FIG. 4.

Resin frame 25 can fix first busbar 10, second busbar 11, and third busbar 12; as a result of resin frame 25 being provided in electronic component module 7, precise positioning of first busbar 10, second busbar 11, and third busbar 12 becomes easy. Particularly, in the case where electronic component module 7 according to Embodiment 4 illustrated in FIG. 5 includes heat dissipator 23 (refer to FIG. 4), heat dissipator 23 (refer to FIG. 4) reliably contacts first busbar 10, and thus heat can be efficiently transferred from first busbar 10 to heat dissipator 23 (refer to FIG. 4). The same as first busbar 10 applies to second busbar 11 and third busbar 12.

Also in electronic component module 7 according to Embodiment 4 illustrated in FIG. 5, insulating layer 24 may be provided as in electronic component module 7 illustrated in FIG. 4. Insulating layer 24 (refer to FIG. 4) is desirably formed from an insulating material having a low modulus of elasticity in order to make the heat transfer from first busbar 10, second busbar 11, and third busbar 12 to heat dissipator 23 efficient.

In electronic component module 7 illustrated in FIG. 5, the surfaces of resin frame 25, first conductor 13, second conductor 17, and third conductor 20 that are located in the direction opposite to the Z direction are disposed in the same plane.

Note that resin frame 25, first conductor 13, second conductor 17, and third conductor 20 do not need to be disposed in the same plane.

Note that the upper surface (the surface in the direction opposite to the Z direction) of each of first conductor 13, second conductor 17, and third conductor 20 may be located at a position lower in the Z direction than the position of the upper surface (the surface in the direction opposite to the Z direction) of resin frame 25. With a recessed portion (not illustrated in the Drawings) formed by resin frame 25 and first conductor 13, a recessed portion (not illustrated in the Drawings) formed by resin frame 25 and second conductor 17, and a recessed portion (not illustrated in the Drawings) formed by resin frame 25 and third conductor 20, resin frame 25 can easily fix heat dissipator 23, and first busbar 10, second busbar 11, third busbar 12, and heat dissipator 23 have a stable positional relationship. Thus, heat is efficiently transferred from first busbar 10, second busbar 11, and third busbar 12 to heat dissipator 23. This configuration is particularly favorable in the case where insulating layer 24 (refer to FIG. 4) is provided on the surface of each of first conductor 13, second conductor 17, and third conductor 20 that is located in the direction opposite to the Z direction.

Note that the surface (the surface exposed from resin frame 25) of each of first conductor 13, second conductor 17, and third conductor 20 that is located in the direction opposite to the Z direction may be located in the direction opposite to the Z direction with respect to the surface of resin frame 25 that is located in the direction opposite to the Z direction. In this case, first conductor 13, second conductor 17, and third conductor 20 protrude from resin frame 25 in the direction opposite to the Z direction. With this configuration, particularly in the case where soft insulating layer 24 having a low modulus of elasticity is used, a portion of insulating layer 24 can be ejected from a region between heat dissipator 23 and each of first conductor 13, second conductor 17, and third busbar 12. This makes it easy to maintain the thickness of insulating layer 24 at an appropriate level between heat dissipator 23 and each of first conductor 13, second conductor 17, and third busbar 12, resulting in efficient heat transfer from first busbar 10, second busbar 11, and third busbar 12 to heat dissipator 23.

### Embodiment 5

FIG. 6 is an external perspective view illustrating the configuration of electronic component module 7 according to Embodiment 5. Electronic component module 7 further includes casing 26 which holds resin frame 25 and to which relay main body 9A is fixed. Note that in FIG. 6, the disclosure of resin frame 25 is omitted in order to make the shape of casing 26 easier to understand. With the configuration illustrated in FIG. 6, heat dissipator 23, first busbar 10, second busbar 11, third busbar 12, and relay 9 have an even more stable positional relationship. As a result, the heat dissipation properties of first conductor 13, second conductor 17, and third conductor 20 further improve.

Note that electronic component module 7 may be fixed by both resin frame 25 (refer to FIG. 5) and casing 26. Electronic component module 7 may be fixed by resin frame 25, casing 26, and relay 9. When electronic component module 7 is fixed by resin frame 25 and casing 26, the vibration of casing 26 due to a hum and so on produced at relay 9 is reduced. When electronic component module 7 is fixed by resin frame 25, casing 26, and relay 9, electronic component module 7 including casing 26 has improved rigidity and as a result, has improved reliability for resistance to vibration, impact, etc.

Note that in Embodiment 5 illustrated in FIG. 6, first connecting conductor 14 is not orthogonal to a plane in which first conductor 13 extends. Specifically, in FIG. 6, first connecting conductor 14 is not bent (in the Z direction) at an angle of 90 degrees, but is bent at an angle smaller than 90 degrees, to first conductor 13. In other words, a direction (z1 direction) in which first connecting conductor 14 extends does not always need to be orthogonal to the X direction and the Y direction, and it is sufficient that the direction (z1 direction) in which first connecting conductor 14 extends cross the X direction and the Y direction. The same as first connecting conductor 14 applies to second connecting conductor 18; a direction (z1 direction) in which second connecting conductor 18 extends does not always need to be orthogonal to the X direction and the Y direction, and it is sufficient that the direction (z1 direction) in which second connecting conductor 18 extends cross the X direction and the Y direction.

Although description has been made using an example in which the angle formed by first conductor 13 and plate-shaped portion 14a of first connecting conductor 14 is less than 90 degrees, the angle formed by first conductor 13 and plate-shaped portion 14a of first connecting conductor 14 may be 90 degrees or more.

Note that also in other exemplary embodiments, the direction in which first connecting conductor 14 extends does not always need to be orthogonal to the X direction and the Y direction, and it is sufficient that the direction in which first connecting conductor 14 extends cross the X direction and the Y direction. The same as first connecting conductor 14 applies to second connecting conductor 18; the direction in which second connecting conductor 18 extends does not always need to be orthogonal to the X direction and the Y direction, and it is sufficient that the direction in which second connecting conductor 18 extends cross the X direction and the Y direction.

### CLOSING

Electronic component module 7 according to the present disclosure includes: fuse 8 including fuse main body 8A, first fuse terminal 8B, and second fuse terminal 8C; relay 9 including relay main body 9A, first relay terminal 9B, and second relay terminal 9C; first conductor 13 having the shape of a plate, first conductor 13 being along the X direction and the Y direction orthogonal to the X direction; first connecting conductor 14 extending from first conductor 13 in the Z direction, which crosses the X direction and the Y direction, and including plate-shaped portion 14a which is along the X direction and the Z direction; second conductor 17 having the shape of a plate which is along the X direction and the Y direction; second connecting conductor 18 extending from second conductor 17 in the Z direction and including plate-shaped portion 18a which is along the X direction and the Z direction; and third conductor 20 having the shape of a plate, third conductor 20 being along the X direction and the Y direction.

First conductor 13, second conductor 17, and third conductor 20 are arranged in the order of third conductor 20, second conductor 17, and first conductor 13 in the first direction. First fuse terminal 8B is connected to plate-shaped portion 14a of first connecting conductor 14, and second fuse terminal 8C is connected to plate-shaped portion 18a of second connecting conductor 18. First relay terminal 9B is connected to end 17a of second conductor 17 that is located in the direction opposite to the X direction. Second relay terminal 9C is connected to end 20a of third conductor 20 that is located in the X direction.

In electronic component module 7 according to the present disclosure, the Z direction may be orthogonal to the X direction and the Y direction.

In electronic component module 7 according to the present disclosure, first conductor 13 may extend in the direction opposite to the X direction with respect to first connecting conductor 14 when viewed in the Z direction.

In electronic component module 7 according to the present disclosure, second conductor 17 may extend in the X direction with respect to second connecting conductor 18 when viewed in the Z direction.

Electronic component module 7 according to the present disclosure may further include heat dissipator 23 thermally coupled to first conductor 13, second conductor 17, and third conductor 20.

Electronic component module 7 according to the present disclosure may further include resin frame 25 which fixes first conductor 13, first connecting conductor 14, second conductor 17, second connecting conductor 18, and third conductor 20 to one another.

Electronic component module 7 according to the present disclosure may further include casing 26 which holds resin frame 25, and relay main body 9A may be fixed to casing 26.

### INDUSTRIAL APPLICABILITY

The electronic component module according to the present disclosure has the advantage of being able to improve the heat dissipation properties thereof without increasing the size thereof, and thus is useful in various electronic devices.

### REFERENCE MARKS IN THE DRAWINGS

1 electronic component module
2 relay
3 fuse
4 first outer conductor
5 second outer conductor
6 inner conductor
7 electronic component module
8 fuse
8A fuse main body
8B first fuse terminal
8C second fuse terminal
9 relay
9A relay main body
9B first relay terminal
9C second relay terminal
10 first busbar
11 second busbar
12 third busbar
13 first conductor
13a end
13b end
14 first connecting conductor
14a plate-shaped portion
14b bent portion
17 second conductor
17a end
17b end
18 second connecting conductor
18a plate-shaped portion
18b bent portion
20 third conductor
20a end
22 fixing tool
23 heat dissipator
24 insulating layer
25 resin frame
26 casing
A position
B position
P1 first plane
P2 second plane
D1 length
L1 length

1. An electronic component module, comprising:
a fuse including a fuse main body, a first fuse terminal, and a second fuse terminal;
a relay including a relay main body, a first relay terminal, and a second relay terminal;
a first conductor having a shape of a plate, the first conductor being along a first direction and a second direction orthogonal to the first direction;
a first connecting conductor extending from the first conductor in a third direction crossing the first direction and the second direction, the first connecting conductor including a plate-shaped portion being along the first direction and the third direction;
a second conductor having a shape of a plate, the second conductor being along the first direction and the second direction;
a second connecting conductor extending from the second conductor in the third direction and including a plate-shaped portion being along the first direction and the third direction; and
a third conductor having a shape of a plate, the third conductor being along the first direction and the second direction, wherein
the first conductor, the second conductor, and the third conductor are arranged in the order of the third conductor, the second conductor, and the first conductor in the first direction,
the first fuse terminal is connected to the plate-shaped portion of the first connecting conductor,
the second fuse terminal is connected to the plate-shaped portion of the second connecting conductor,
the first relay terminal is connected to an end of the second conductor, the end of the second conductor being located in a direction opposite to the first direction, and
the second relay terminal is connected to an end of the third conductor, the end of the third conductor being located in the first direction.

2. The electronic component module according to claim 1, wherein
the third direction is orthogonal to the first direction and the second direction.

3. The electronic component module according to claim 1, wherein
the first conductor extends in the direction opposite to the first direction with respect to the first connecting conductor when viewed in the third direction.

4. The electronic component module according to claim 1, wherein
the second conductor extends in the first direction with respect to the second connecting conductor when viewed in the third direction.

5. The electronic component module according to claim 1, further comprising:
a heat dissipator thermally coupled to the first conductor, the second conductor, and the third conductor.

6. The electronic component module according to claim 1, further comprising:
a resin frame fixing the first conductor, the first connecting conductor, the second conductor, the second connecting conductor, and the third conductor to one another.

7. The electronic component module according to claim 6, further comprising:
a casing holding the resin frame, wherein
the relay main body is fixed to the casing.
